(19) United States
(12) Patent Application Publication
(10) Pub. No.: US 2008/0074493 A1
(43) Pub. Date: Mar. 27, 2008

(54) Method and apparatus for providing audio comments about a product or service

(76) Inventor: Eric Laughlin, Morrison, CO (US)

Correspondence Address: RATNERPRESTIA, P O BOX 980, VALLEY FORGE, PA, 19482-0980, US

(21) Appl. No.: 11/514,474

(22) Filed: Sep. 1, 2006

(51) Int. Cl. H04N 7/18

(52) U.S. Cl. 348/143

(57) ABSTRACT

A method and apparatus for providing audio comments about a product or service records audio comments provided by users of the system. The recorded audio comments are associated with an indicated product or service on a web-site. A link is generated between the recorded audio comments and an indicator of the indicated product or service, enabling other users to listen to the audio comments.

### BACKGROUND OF THE INVENTION

Careful shoppers like to obtain objective reviews of products or services before choosing one for purchase. Apart from “word of mouth” such reviews have been traditionally written and then read by numerous individuals. Even with the advent of global information networks (e.g. the Internet), comments on products are still provided in written form. Review sites that are connected to the Internet require users to type in their comments. This can be a barrier for many reasons such as the reviewer's typing skills or their comfort with putting their comments in written form.

### SUMMARY OF THE INVENTION

The present invention is embodied in a method and apparatus for providing audio comments about a product or service.

The exemplary method includes the steps of prompting a user to indicate a product or service, receiving from the user an indication of the product or service, receiving audio comments from the user related to the indicated product or service, associating the recorded audio comments and the indicated product or service, and generating a link between the recorded audio comments and an indicator of the indicated product or service. The exemplary method enables the user and others to access and listen to the audio comments.

The exemplary apparatus includes a first information transmission system coupled to an audio transceiver system; an audio record/playback system in two-way communication with the audio transceiver system via the first information transmission system, which receives and records the audio comments; and an information storage system, which is configured to receive and store the recorded audio comments from the audio record/playback system and to generate and provide for display a link to the recorded audio comments. The apparatus enables the user and others to access and listen to the audio comments.

### BRIEF DESCRIPTION OF THE DRAWINGS

FIG. 1 shows a flow chart showing one embodiment of a method for providing audio comments about a product or service.

FIG. 2 shows a functional block diagram of an embodiment of an apparatus for distributing audio comments about a product or service.

### DETAILED DESCRIPTION OF THE INVENTION

The advent of new communication technologies such as sophisticated cell phone systems and computer-based phone systems such as “Voice over Internet Protocol” (VoIP) have made the widespread distribution of audio comments possible. It has opened up new methods of communication such as voice-based e-mail, instant messaging and text messaging. Although much of the description presented below concerns vocal comments, it is contemplated that the term “audio” is much broader and may include other types of sound information such as recorded music, a test tone or a sequence of tones that may be used, for example, to provide an indication of the fidelity of a service.

Using an exemplary system according to the present invention, a user may employ a POTS telephone, a cellular telephone, a voice-over Internet Protocol (VoIP) system or other audio communication method to provide comments regarding a product or service that may be posted, for example, on an Internet web site so that other potential users of the product or service may listen to them.

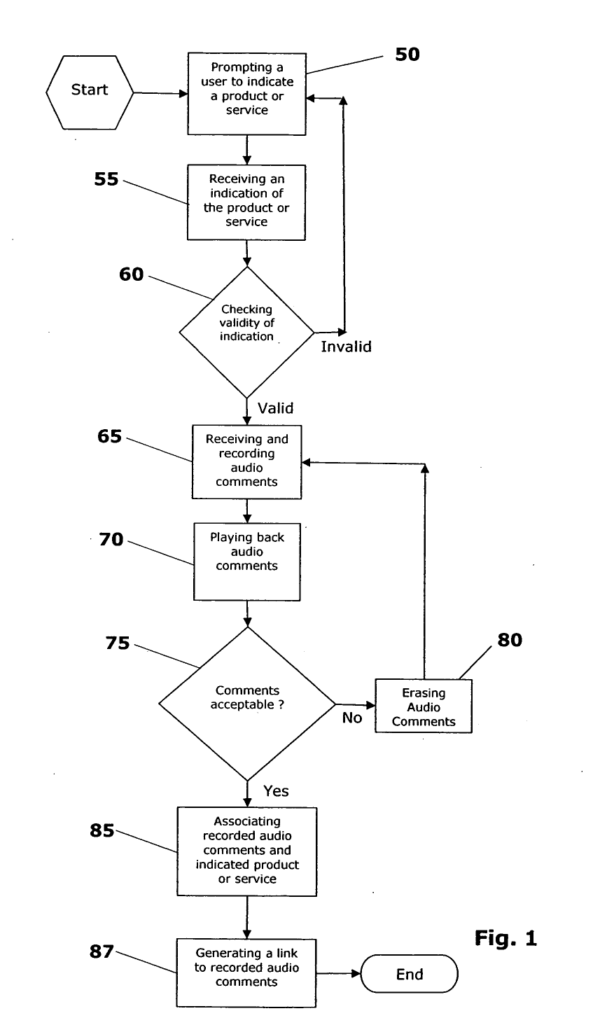

FIG. 1 is a flow chart showing one embodiment of a method for providing audio comments about a product or service. In FIG. 1, and in the following disclosure, the embodied method is disclosed from the point of view of a device, such as a server, which is sending information to and receiving information from a client or user. A single point of view is chosen for clarity and consistency of disclosure; however the particular one chosen here is arbitrary. The user point of view, for example, could also have been chosen.

The described method may be used with a variety of products or services. One type of service for which it may be particularly useful is a VoIP telephone service. Services of this type are widely available through providers such as Skype® and Vonage® among others. Using a service of this type, a user may call a number or VoIP userID associated with the web site and, responsive to prompts, record comments on the service. Because the service is used to provide the comments, an interested party may judge the system not only based on the comments of the user but also on the quality of the recorded call.

The exemplary method begins at step 50 by prompting a user to indicate a product or service. If the user accessed the comment site using a web browser, this may be done by selecting from among displayed icons on the web-site using a pointing device such as a computer mouse, trackball or other similar device. If the user accesses the system by telephone, cellular phone or other audio device (e.g. a microphone connected to the user's computer), this may also be done by transmitting voice prompts to the user and instructing the user to indicate a selection by speech or by using buttons on a keypad or keyboard. These prompts may, for example, ask the user to select from among a set of products or services. Other prompts, described below, can be provided to the user in the same ways.

After prompting the user to indicate the product or service on which comments are to be provided, the system, at step 55 receives from the user an indication of the selected product or service. This indication may take the form of a mouse click, a spoken response or a one or more Digital Tone Multi-Frequency (DTMF) signals or sensed keystrokes which are interpreted by the server to determine what product or service has been selected. At step 60, after receiving the indication from the user the system may determine whether a valid selection has been made. For example, if the user is prompted to push the keys 1, 2, 3, or 4 on a telephone keypad to select from among four products or services and the user accidentally pushes 5, step 60 would determine this selection to be invalid. If an invalid selection is made, the user is again prompted to indicate a product or service at step 50, described above.

If a valid selection is made at step 60 the user may be prompted to begin providing audio comments at step 65. Audio comments from the user related to the indicated product are received 65. Audio comments may be received at step 65 in numerous ways. One exemplary way is receiving and storing a pre-recorded audio file that is uploaded by the user. Another is receiving a voice signal, for example in a telephone call from a POTS telephone, cell phone or VoIP system, and recording the signal as it comes in using a conventional Interactive Voice Response (IVR) system. Regardless of the form in which the audio comments are received, they are recorded at step 65.

After the audio comments are recorded, the system may play them back to the user at step 70. After the user listens to the playback, the system may prompt the user, at step 75, to either erase or store the recorded audio comments. If the user so chooses, the recorded audio comments may be erased at step 80, the user may then be prompted to provide and store new audio comments as described above with reference to step 65 through 70.

Once the recorded audio comments are accepted and recorded, the next step, 85, associates the recorded audio comments and the indicated product or service in a database (not shown) on the server. An exemplary database may, for example, include a group of records for each of several products. In addition to the commentary material, each of these records may indicate a user, for example, by using a name entered by the user in response to a prompt, a caller-ID telephone number, VoIP userID or IP address, and a date and time at which the comment was made. It is contemplated that the system also provide the user with the option of remaining anonymous. Using this information, the system may automatically filter out multiple calls made by a single user, providing only the last call. Alternatively, the system may generate an identifier from the information and display all of the messages with the identifying information to allow the user to filter-out multiple comments by the same user. In this example, it is contemplated that all anonymous comments would be linked together.

The last step in the process, step 87, generates a link between the recorded audio comments and the indicated product or service. In this way, the user and others are enabled to access and listen to the audio comments. If a database is used to store the comments, this step may link the comment record to other records for the product or service. The system may add the comment to a web page. For example the indicator may be an icon formatted to appear on a computer display, naming the indicated product or service, and having the appearance of buttons on a CD player. Clicking on the icon may enable playback of the audio comments. Alternatively, an indicator for each audio comment may be displayed below the icon and the indicator may include a hyperlink to the audio data.

In addition to the steps disclosed above, the disclosed method may also include the steps (not shown) of receiving and storing textual comments from the user related to the indicated product or service, associating the textual comments with the recorded audio comments and the indicated product or service, and formatting the textual comments with the indicator and the link to the recorded audio comments for display. For example, textual comments might be received character-by-character as it is typed by the user, in the form of an uploaded text file or in the form of a text message transmitted from a cell phone.

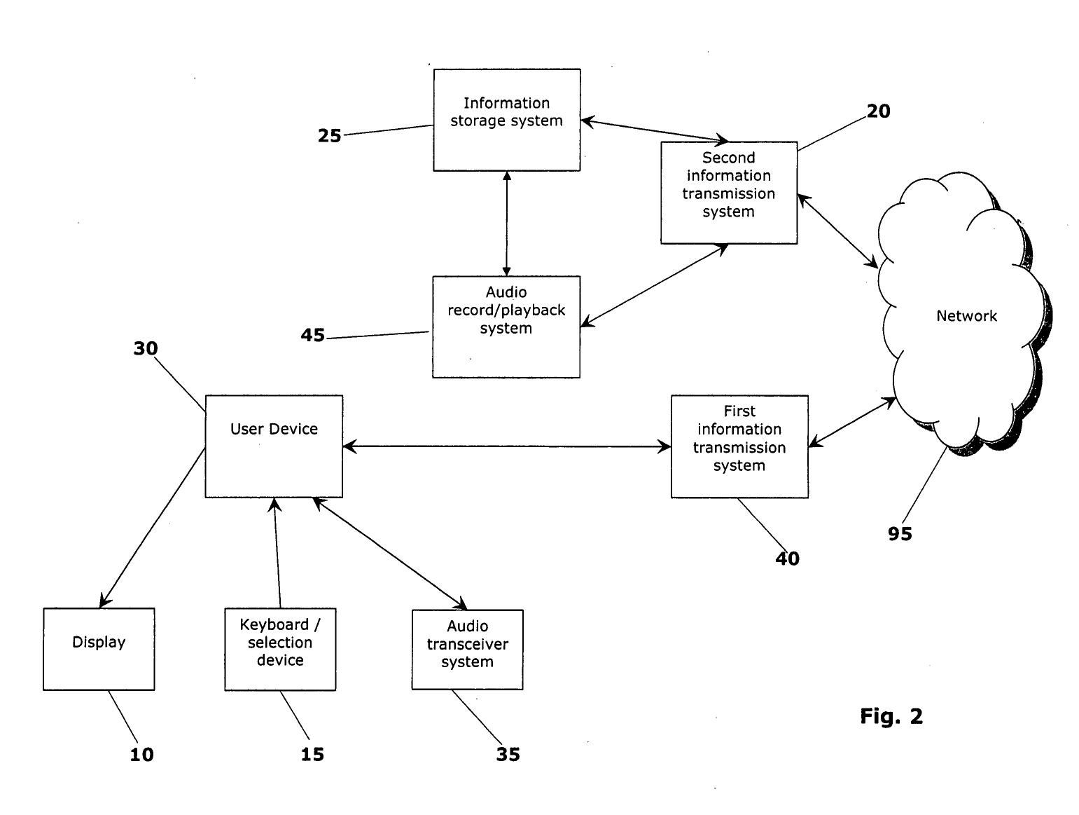

FIG. 2 shows a functional block diagram of an exemplary embodiment of an apparatus for receiving and publishing audio comments about a product or service. The system includes a user device 30 which may, for example, be a personal computer, POTS telephone, cellular telephone or web-enabled cellular telephone. The user device 30 may include a display 10, a keyboard/keypad or selection device 15 and an audio transceiver system 35, such as a microphone and earphone or speaker and associated audio signal processing hardware and/or software. The user device 30 is coupled to a first information transmission system which may, for example, be a line-card in a central office switch or a cellular switch if the device 30 is a telephone or cellular telephone, a cellular network IP interface if the device 30 is an Internet-enabled cellular telephone or an Internet service provider (ISP) if the user device 30 is a personal computer or VoIP telephone.

The first information transmission system 40 may communicate with a second information transmission system 20 via a network 95. If the user device 30 is a telephone or a cellular telephone, the network may be a telephone network. For other devices, it may be a global information network, such as the Internet. Although the exemplary embodiment uses the Internet, it is contemplated that other types of networks, such as conventional local area networks, wide-area networks or even relatively stable ad-hoc networks may be used.

In addition to the second information transmission system 20, the server side of the exemplary system includes an information storage system 25 and an audio record/playback system 45. The Audio record/playback system 45 may be a conventional IVR system which may have a one-way or two-way communication link with audio transceiver system 35 via the first and second information transmission systems 20 and 40. The Information storage system 25 and audio record/playback system 45 may be implemented using software in a conventional Internet Server.

In the exemplary embodiment, audio record/playback system 45 is controlled by a program running on the information storage system 25 to prompt users for comments and to receives the comments, as described above with reference to FIG. 1. The system 25 may then store comments in a database (not shown), also as described above. The information storage system may also include voice recognition software (not shown) to recognize verbal responses to the prompts. It is contemplated that this voice recognition software may convert at least some of the responses provided by the user into text files that may be provided to other users of the system. This information may include, for example, any identifying information provided by the user or a numerical rating of the product or service. Alternatively, the voice recognition system may translate the entire audio comment provided by the user into a text file and link this text file into the database to augment or replace the recorded audio comment.

A user may also provide textual comments, along with the audio comments, using the keyboard selection device 15, as described above. When both textual and audio comments are provided, the information storage system 25 may link them together so that the textual comments are displayed while the audio comments are played-back by the audio record/playback system 45.

Exemplary information storage system 25 may be configured to store the recorded audio comments from audio record/playback system 45 and to generate and provide for display a web page including links to the recorded audio comments. The link enables a user and others to access and listen to the audio comments. Information storage system 25 may also be configured to receive and store other types of information, such as symbolic information, including textual information. Information storage system 25 may or may not be collocated with audio record/playback system 45; both may be components of a server. When the user device 30 may be a telephone or cellular telephone, the information storage system may include a single-line or multi-line telephone answering device (not shown) and a DTMF interface (not shown) to couple the telephone signal received from the system 20 into the system 25.

As an example of how the system may be used, consider an embodiment in which the user device is a personal computer running VoIP software or a VoIP-telephone. In this embodiment, the user may connect to the information storage system 25 through the second information transmission system 20 using a telephone number, Universal Resource Locator (URL), VoIP userID or IP address. Once this connection has been established, the system 25 may display a web-page on the user's display 10 or provide audio prompts to the user through a VoIP connection. As described above, with reference to FIG. 1, the user may then enter comments using the VoIP connection, which are then stored on the information storage system 25 and linked on a web page to an icon indicating the VoIP system through which the call was made.

While exemplary embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the scope of the invention.

What is claimed:

1. A method for providing audio comments about a product or service, the method comprising the steps of:
prompting a user to indicate a product or service;
receiving from the user an indication of the product or service;
receiving audio comments from the user related to the indicated product or service;
associating the recorded audio comments and the indicated product or service, and
generating a link between the recorded audio comments and an indicator of the indicated product or service, thereby enabling the user and others to access and listen to the audio comments.

2. The method of claim 1, wherein the step of receiving audio comments comprises receiving an uploaded audio file.

3. The method of claim 1, wherein the step of receiving audio comments comprises recording the audio comments.

4. The method of claim 1, wherein the step of receiving audio comments comprises receiving a call from one of a telephone, a cellular telephone, a VoIP enabled telephone, or a computer coupled to a VoIP system.

5. The method of claim 1, wherein the step of receiving the audio comments further comprises the step of providing the user with a playback of the recorded audio comments.

6. The method of claim 5 wherein the step of providing the user with a playback further comprises the steps of prompting the user to erase the recorded audio comments, erasing the recorded audio comments, and receiving new audio comments from the user.

7. The method of claim 1 further comprising the steps of:
receiving and storing textual comments from the user related to the indicated product or service;
associating the textual comments with the recorded audio comments and the indicated product or service; and
formatting the textual comments with the indicator and the link to the recorded audio comments for display.

8. Apparatus for distributing audio comments about a product or service, the apparatus comprising:
a first information transmission system, coupled to an audio transceiver system;
an audio record/playback system in two-way communication with the audio transceiver system via the first information transmission system, which receives and records the audio comments; and
an information storage system, which is configured to receive and store the recorded audio comments from the audio record/playback system and to generate and provide for display a link to the recorded audio comments, thereby enabling the user and others to access and listen to the audio comments.

9. The apparatus of claim 8, further comprising a second information transmission system coupled to the information storage system.

10. The apparatus of claim 9, wherein the first and second information transmission systems are coupled to a global information network.

11. The apparatus of claim 9, further comprising a symbolic input device which transmits symbolic information to the information storage system through the second information transmission system, the information storage system associating the symbolic information with the link.

12. The apparatus of claim 11, wherein the symbolic input device comprises a computer keyboard, a telephone keypad, a selection device, or a voice recognition system.

13. The apparatus of claim 11, wherein the symbolic information comprises textual comments concerning the product or service.

14. The apparatus of claim 11, wherein the symbolic input device comprises a voice recognition system and the information storage system is configured to translate the received audio comments into text comments using the voice recognition system and to store the text comments in place of the recorded audio comments.

15. The apparatus of claim 14, wherein the information storage system is further configured to provide prompts for identifying information, to convert the audio comments received in response to the prompts for identifying information into the text comments, and to associate the converted text comments with the link to identify a source of the audio comments.

16. The apparatus of claim 8, wherein the audio transceiver system includes an interface to a telephone network to receive the audio comments.

17. The apparatus of claim 8, wherein the audio transceiver system includes an interface to a VoIP network to receive the audio comments.

18. The apparatus of claim 8, wherein the audio record/playback system comprises an Interactive Voice Response system.

19. The apparatus of claim 8, wherein the product or service being commented on comprises at least one of the audio transceiver system and the first information transmission system, audio quality of the audio comments serving as an indication of audio quality of the product or service.
